(19) United States
(12) Patent Application Publication
(10) Pub. No.: US 2016/0067533 A1
(43) Pub. Date: Mar. 10, 2016

(54) Fire Prevention Capsules and Method of Use

(71) Applicant: Serghei Eriomenco, Philadelphia, PA (US)

(72) Inventor: Serghei Eriomenco, Philadelphia, PA (US)

(21) Appl. No.: 14/480,389

(22) Filed: Sep. 8, 2014

(51) Int. Cl. A62C 8/00; A62C 3/07

(52) U.S. Cl. CPC A62C 8/005; A62C 3/07

(57) ABSTRACT

A fire prevention device is provided for arresting the formation of fires and suppressing those that are already ablaze. The device is a hollow shell willed with a powdered flame retardant and a small weighting element. The shell disintegrates at high temperatures releasing the flame retardant into a flaming area. A weighting element helps carry the device close to the heart of a fire prior to shell disintegration. When the flame retardant is released it falls on the flames, suppressing them and preventing the fire from spreading. A variety of uses are provided including lining automobile engine hoods and chemical transportation tanks with the capsules, placing them as packing fill inside crates of volatile material, lining ceilings with the balls, and others.

### BACKGROUND OF THE INVENTION

### Field of the Invention

The present invention relates to a method of deterring and extinguishing fires. More specifically, it relates to a method of using heat soluble capsules filled with a flame retardant powder to put out fires. The capsules can be stored in the interior cavities of objects to prevent them from burning. The capsules can also be introduced onto materials that are already on fire, to extinguish the flames.

Fire presents a constant threat in dry, high temperature environments, factories, and any location where sparks are regularly produced. If they are not quickly suppressed, fires can spread and cause substantial loss of property and potential losses of human life. The larger the fire grows, the more unmanageable it becomes. Wildfires, which are self-sustaining, can last for days or months as fire crews struggle to combat the blaze. Small fires can often be suppressed by throwing water, foam fire suppressant or the like, on the blaze. Larger fires, that have become self-sustaining, require a multifaceted approach. This may include dumping water on the fire, destroying potential fuel sources, digging large ditches, steering the fire towards bodies of water, as well as other approaches. All of these strategies require active participation by the user to address a fire that is already occurring. They are not as useful for preventing fires from forming.

Passive fire prevention methods typically include constructing objects from flame retardant materials or using a flame retardant coating on objects made from flammable substances. For example, children's clothing, mattresses, and some machinery, are coated in flame retardant chemicals to reduce the likelihood of fire-related user injuries. The trouble with passive prevention methods is that they do not extinguish the fire; they simply reduce the likelihood that the object in question will burn. A device and method of providing fire prevention and suppression is needed to prevent objects from burning and extinguish fire in the surrounding environment.

### DESCRIPTION OF THE PRIOR ART

The present invention is a hollow shell filled with a flame retardant powder and a weighting element. A method of using a plurality of the balls is described for fire prevention. The shell of the balls is easily destroyed by high temperatures or flame, releasing the powder contents and weighting element into the surrounding environment. A large grouping of these balls may be used for fire prevention by lining objects with the balls to extinguish any flames near the object. The balls can also be used to actively combat existing fires by introducing the balls into flames. Other devices and methods for using capsulated flame retardant materials to extinguish fires have been used. But the present invention provides two novel advantages in that it uses a powder rather than a liquid or gaseous flame retardant and it includes a weighting element. The present invention thus provides improved distribution of the flame retardant material and increases the chance that the balls will reach the core of a fire.

Barriers containing pockets or cells of flame retardant material have been used for fire prevention in structural walls and protective barriers. A method of using balls containing a flame retardant substance is described in Kreske, Jr., U.S. Pat. No. 4,100,970. A method for making small plastic balls filled with a liquid substance is disclosed in conjunction with a method of constructing a wall panel made of the liquid filled balls and a collection of air filled balls. When flame is introduced to the panel the liquid in the balls vaporizes, exerting outward pressure on the ball shells. As the temperature increases, the balls burst, sending the vaporized liquid into the fire. A similar invention disclosed in Goodworth, U.S. Pat. No. 6,915,861, is a bubble wrap panel having cells filled with a flame retardant material. A thin flexible plastic is used to create the bubbles and a second thin plastic is used to form a bonding membrane between the bubbles, thus forming a sheet of cells. This sheet of bubble wrap is placed in areas where explosive impacts may occur, such as military installations, firing ranges, and other places where ballistic incendiary devices may be used. Unlike the panels of Kreske, Jr., the bubble wrap is designed to break upon impact rather than temperature increase. When the sheet of bubble wrap is struck, the cells burst exposing flame retardant liquid or powder.

Encapsulated flame retardant materials have also been used loosely to combat existing fires. A method of projecting encapsulated dry ice (Carbon Dioxide frozen into a solid form) into a forest fire is disclosed in Primlani, U.S. Pat. No. 5,507,350. The dry ice capsules are stored at forest ranger stations and then loaded into a capsule launching device when a fire arises. The projectiles are launched into the fire from perimeter locations around the fire. The perimeter locations are based on the direction in which the wind is blowing, obstacles in the path of the fire, and the surrounding geography. Balls containing encapsulated carbon dioxide in a liquid or gaseous form are disclosed in Edwards, U.S. Pat. No. 6,725,941. The Edwards balls are introduced into a flaming environment. Where the plastic shell bursts, exposing the gas or liquid to the fire. The liquid or gaseous flame retardant substance will smother the fire or trigger an oxygen deficiency in the surrounding air, choking the flames.

These prior art devices have several known drawbacks. None of the flame retardant balls or methods of use described above, teach the use of powder and weighting elements. The present invention provides improved distribution of the flame retardant material throughout the affected environment, and improved introduction of the balls into same. In this way, the present invention substantially diverges in design elements from the prior art and consequently it is clear that there is a need in the art for an improvement to existing encapsulated fire extinguishing devices. In this regard the instant invention substantially fulfills these needs.

### SUMMARY OF THE INVENTION

In view of the foregoing disadvantages inherent in the known types of encapsulated flame retardant devices now present in the prior art, the present invention provides a new improved delivery means wherein the same can be utilized for providing convenience for the user when preventing or extinguishing fires.

The present invention is a fire prevention device that comprises a hollow geometric shell filled with a powdered flame retardant material and a weighting element. The shell is constructed of a material that rapidly disintegrates at high temperatures or upon exposure to flame. When the capsule is introduced into a high temperature environment, the shell begins to break down, releasing its contents. The flame retardant powder disperses amongst the surrounding environment. Updrafts caused by hot air help carry the particulate material across the affected area. Weighting elements enclosed within the capsules weigh it down, carrying it further into the core of a fire before the shell disintegrates. This helps prevent early release of the powdered material prior to its reaching the core of a fire.

The balls may be used in conjunction with a variety of fire prevention techniques. In one embodiment the balls form a lining layer along the interior surface of an automobile hood or other engine housing. Alternatively, the balls can be placed within a ceiling such that activation of a fire detection system results in dropping of the balls into the affected room. The balls can also be used as pacing material for flammable substances or to line the interior of tanks used to ship volatile chemicals. Conventional fire fighting methods may also employ the balls. For example, they may be dropped from a plane onto a forest fire or projected into a burning building. Thus, the present invention provides several versatile methods of use.

It is therefore an object of the present invention to provide a new and improved fire prevention device and methods of use that has all of the advantages of the prior art and none of the disadvantages.

It is therefore an object of the present invention to provide a fire prevention device that disperses flame retardant material across an affected area.

Another object of the present invention is to provide a fire prevention device that reaches a position near the core of a fire prior to dispersing suppression materials into the blaze.

Yet another object of the present invention is to provide a method of lining engine housings and chemical tanks with encapsulated fire suppressants.

Still another object of the present invention is to provide a method for using a fire prevention device as packing material for shopping of flammable materials.

Yet another object of the present invention is to provide a fire prevention device that can be easily integrated into conventional fire suppression methods.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is an exemplary embodiment of the fire prevention device. The powdered flame retardant substance and weighting element are viewable through the hollow shell of the capsule.

FIG. 2 shows a perspective view of a plurality of the flame prevention capsules lining the hood of an automobile.

FIG. 3 shows a perspective view of a plane dropping a large number of the encapsulated flame retardant on a forest fire.

FIG. 4 shows a perspective view of a number of the fire prevention devices used for packing material in a box containing a flammable substance.

### DETAILED DESCRIPTION OF THE INVENTION

Reference is made herein to the attached drawings. Like reference numerals are used throughout the drawings to depict like or similar elements of the fire prevention device and method of use. For the purposes of presenting a brief and clear description of the present invention, the preferred embodiment will be discussed as used for preventing fires from happening and suppressing ongoing fires. The figures are intended for representative purposes only and should not be considered to be limiting in any respect.

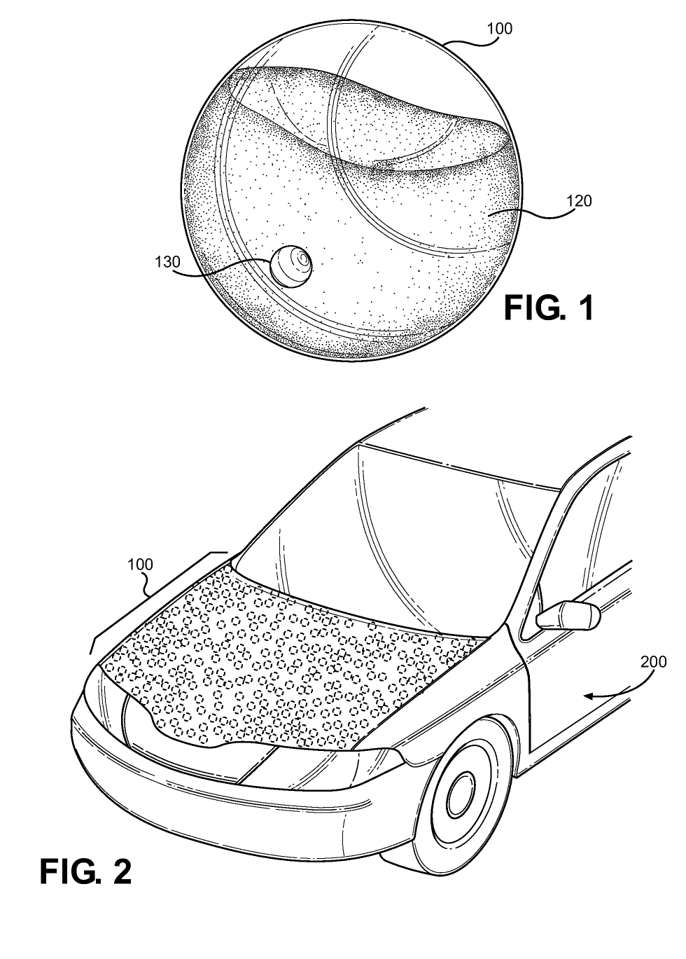

Referring now to FIG. 1, there is shown an encapsulated flame retardant powder for preventing fires. A hollow shell 100 houses a powder substance 120 and a weighting element. The shell is shown in the figure as a spherical capsule, but other geometric shapes such as cubes, diamonds, octagons, and the like are also acceptable. Shapes may be determined during manufacturing according to the specific intended use of the device. Similarly, the weighting element 130 may have any shape desired by the manufacturer or the user.

The shell of the device is a hollow housing for the powdered substance and weighting element. Ideally, the shell will be constructed of a flame suppressant material such as mica powder that is pressed into a thin shell shape and bonded with a lightweight bonding agent. Use of flame retardant substances in shell construction further assists in fire suppression because the shell will break up and disperse into the fire along with the powdered interior contents. In this way, additional flame retardant is introduced into a fire, without an increase in the size of the device. Flame retardant shell composition will likely be more environmentally friendly than materials such as plastic, because the decomposition of the shell will not introduce charred solids into the surrounding environment. If the shell is made of a non-flame retardant material it is preferable that the shell is constructed of a material that undergoes rapid thermal decomposition at high temperatures. Fast disintegration of the shell permits delivery of the flame retardant powder into the affected area before the shell is engulfed in flames. Thin plastics and polyvinyl are useful as shell composition materials, but others may also be used, so long as they exhibit rapid thermal decomposition qualities.

A powdered flame retardant substance is contained within the hollow shell and disperses into a fire upon shell disintegration. The powdered substance may be aluminum hydroxide Al(OH)₃, Mica powder, Silicon Carbon, and phosphorous/nitrogen blends, or any other flame retardant powder known in the art to provide high flame retardant qualities. The determination as to what constitutes a “high flame retardant” property is made by industry safety boards and organizations such as the occupational safety and health administration (OSHA). Thus this rating may change over time, but it should be understood that the powdered substances listed above are for exemplary purposes and that the capsules contents can be changed to comply with industry regulations and best practices regarding fire prevention.

A dense weighting element is contained within the hollow shell to assist with flame retardant delivery. Because the powdered substance is lightweight, the filled shell is susceptible to being blown around by fire updrafts. These updrafts are strong air currents caused by the rapid heating of air in the area near a fire. The larger the fire grows, the more substantial the distortions in the air become. Flame retardant granules released during shell disintegration can be blown around by updrafts and air distortions, making it difficult for the material to reach the core of a fire, where it can be the most effective. To solve this problem, the present invention includes a small solid geometrical shape to weight the device down, helping it travel further into a fire before the shell disintegrates and releases powder into the flames. The weighting element may be a densely packed mass of flame retardant material. In this preferred embodiment, the powdered flame retardant will be dispersed throughout a fire and the weighting element will drop into the fiery core. If the shell is also made of a flame retardant powder then a third form of delivery is effectively provided. The weighting element does not need to be composed of the same flame retardant material as the powdered substance and the hollow shell. The mass and bonding characteristics of flame retardant substances will determine which materials are best suited for use as a shell, powdered substance or weighting element. Other materials may also be used for weighting elements, such as metals, and non-flammable substances. Metals are excellent for adding weight to the device but may be less desirable in some methods of use because the weights will remain in the environment after a fire is suppressed, necessitating cleanup.

Referring now to FIG. 2, there is shown an example of the method of using the fire prevention capsules as a liner for the interior of a volume containing a combustible element. In this figure, the automobile 200 has a front hood that is lined with the fire prevention capsule, so that the capsules can be immediately activated in the event of engine fire. The capsules may also be used along other interior surfaces of the engine housing. In general, the surface best suited to use with the encapsulated flame retardant will be that which is directly above the engine because flame reaches upward to find oxygen. Similarly, any defined volume can be lined with the fire prevention devices to reduce the likelihood of burning. Engine housings, automobile, plane and boat compartments, chemical tanks, and even room walls and ceilings, For example, the interior of a chemical transportation tank can be lined with the capsules, to provide fire prevention and suppression in the event that there is an accident during transit and the chemicals ignite. Additionally, the capsules can be used to line a ceiling, or stored in a cavity just above the interior surface of a ceiling so that activation of a fire alarm causes ejection of the capsules into the room, where they can suppress a fire. Rooms such as storage facilities and laboratories may be likely to store combustible chemicals or other volatile materials. A fire suppression system utilizing just water sprinklers may be insufficient to address the fire prevention needs of these facilities and thus the fire prevention capsules can add much needed suppressant capabilities.

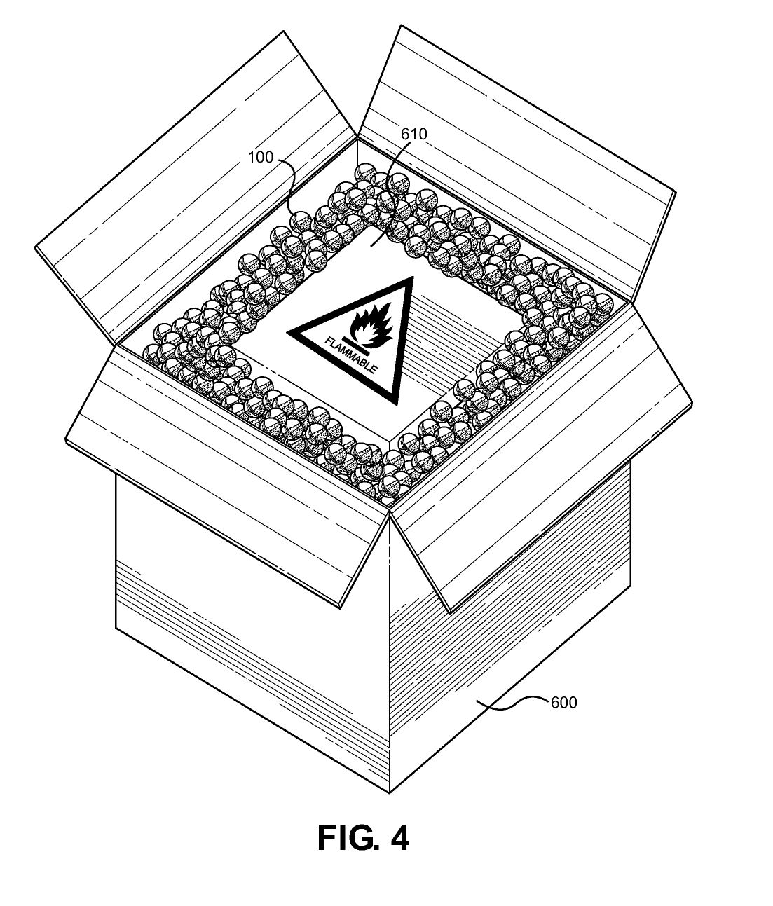

Turning now to FIG. 4, there is shown an alternative example of the method of using the fire prevention capsules in conjunction with a container containing a combustible element. In this example, a number of the fire prevention capsules 100 are used as packing fill material for a container. The packaging container 600 houses a flammable element 610 such as a highly combustible chemical. Fire prevention capsules 100 fill the spare volume of the container and surround the combustible element. If the combustible element is ignited during shipping due to shaking or impact, the fire prevention capsules will activate, suppressing the flames and preventing the fire from spreading to other packages and containers. In this manner the fire prevention capsules are used to fill a volume rather than to line interior surfaces of the volume as described above.

The primary method of the present invention addresses both the lining and filling of interior volumes. An appropriate interior volume is selected by the manufacturer or the user. It is then determined whether the volume should be lined or filled with the flame prevention capsules. Selection of an appropriate interior volume is based on the risk of fire ignition and difficulties presented by standard fire control methods. The fire prevention capsules are best suited for situations where sprinklers and slurries are not practical options. Thus an interior volume that will house a combustible device or chemical, and is not accessible to conventional fire prevention methods, will be ideal for use with the fire prevention capsules. Lining of interior volumes is appropriate where spare volume is needed for air, other objects, or people. Conversely, filling of the volume is best suited when impact protection and immobilization of the combustible element are concerns. The capsules are then applied to the interior volume according to the determination of lining or filling. A bonding agent such as glue or other adhesive may be applied to an interior surface of the volume and the capsules affixed thereto. Containers may be filled via insertion of the capsules into the interior volume until it is full. Once the interior volume is properly filled or lined, the volume is ready for its regular use.

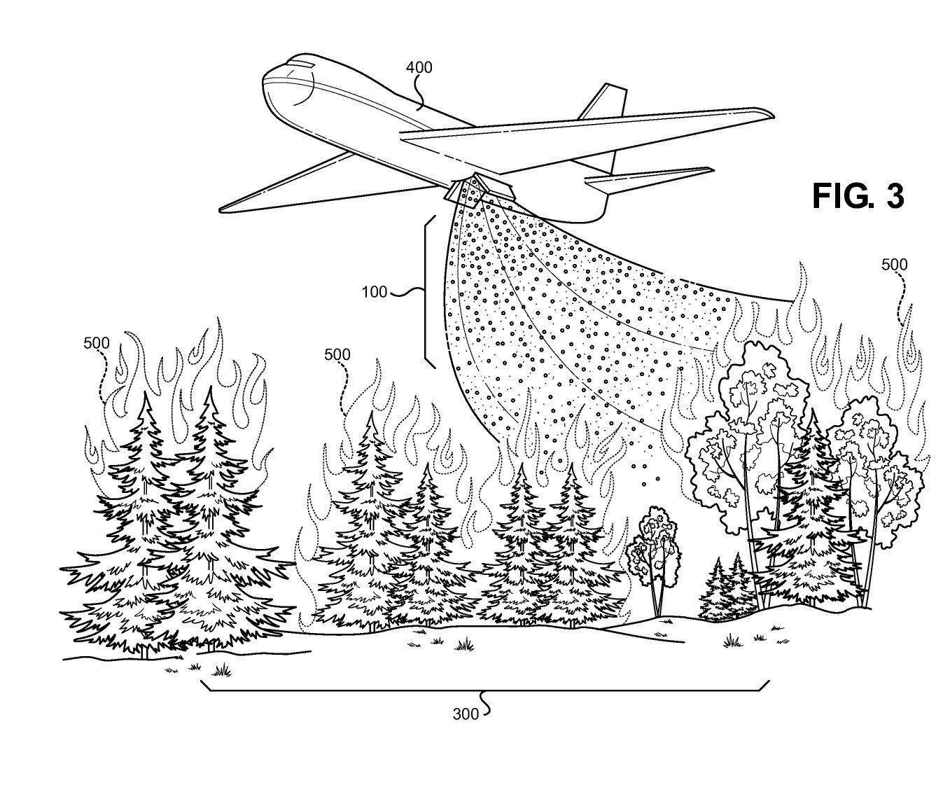

Turning now to FIG. 3, there is shown a picture of the flame prevention capsules as used in traditional fire fighting methods. A forest fire 500 engulfs a forest of trees 300 while a plane 400 flies over the blaze, dropping fire prevention capsules. Wildfires and brush fires are commonly treated by dropping large volumes of water or other flame retardants on the fire. Ditches may also be dug to steer fires or prevent the fire from spreading in a particular direction. Current methods are problematic because they require large volumes of water that must be sent to a landing strip and loaded onto the plane. Water is extremely heavy in large quantities; therefore planes can only hold a certain amount at each time. Many rounds of water dropping are needed to suppress the blaze. Each trip uses fuel and requires paying pilots and firefighters to man the flight. Over time, these procedures become costly. The present invention provides lightweight fire prevention capsules that can be dropped from the plane in the same manner as water. Use of the capsules negates the need for using large quantities of water, which is a valuable resource in most dry environments. In this manner, the present invention provides a method for using the fire prevention capsules with conventional fire fighting techniques.

The present invention is a fire prevention device and method comprising a hollow shell, a powdered substance, and a weighting element. Both the hollow shell and weighting element may be constructed of flame retardant material or other suitable materials as described above. The powdered substance is a flame retardant that is dispersed amongst a fire when the hollow shell disintegrates. Therefore, use of the invention to suppress a fire introduces at least one and up to three different types of flame retardant material into a fire. The capsules reduce the need for water consumption in fire suppression, and provide a fire prevention and suppression device that can be safely and easily stored when not in use.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fire prevention capsule comprising:
a hollow shell;
a powdered flame retardant housed within said hollow shell;
a weighting element housed within said hollow shell.

2) The device of claim 1, wherein said hollow shell is constructed of a flame retardant substance.

3) The device of claim 1, wherein said weighting element is a densely packed flame retardant.

4) A method of fire prevention, comprising the steps of:
selecting an interior volume for fire prevention treatment, wherein said interior volume houses one or more combustible elements;
determining whether said interior volume should be lined with fire prevention capsules or filled with fire prevention capsules;
applying said fire prevention capsules comprising a hollow shell, powdered substance, and weighting element to sad interior volume.

5) The method of claim 4, wherein said selection of said interior volume is based on the risk of fire presented by said combustible element.

6) The method of claim 4, wherein said determination is based on the need for empty space within said interior volume.

7) The method of claim 4, wherein said applying comprises filling an interior volume with a plurality of fire prevention capsules.

8) The method of claim 4, wherein said applying securing a plurality of fire prevention capsules to an interior surface of said interior volume with an adhesive.

9) A method of fire suppression using fire prevention capsules, comprising the steps of:
filling a storage space in an airplane or helicopter with fire prevention capsules comprising a hollow shell, a powdered substance, and weighting element;
flying over a fire;
dropping said fire prevention capsules onto said fire.
